(19) United States
(12) Patent Application Publication
(10) Pub. No.: US 2015/0074597 A1
(43) Pub. Date: Mar. 12, 2015

(54) SEPARATE SMOOTHING FILTER FOR PINCH-ZOOMING TOUCHSCREEN GESTURE RESPONSE

(71) Applicant: NVIDIA Corporation, Santa Clara, CA (US)

(72) Inventor: Olli ETUAHO, Helsinki (FI)

(73) Assignee: NVIDIA Corporation, Santa Clara, CA (US)

(21) Appl. No.: 14/023,827

(22) Filed: Sep. 11, 2013

(51) Int. Cl. G06F 3/0484; G06F 3/0485

(52) U.S. Cl. CPC G06F 3/0484; G06F 3/0485
USPC 715/800

(57) ABSTRACT

A device including a touch screen display may be configured to selectively filter touch input. The device may receive a plurality of touch events. The device may determine whether the touch events correspond to a scaling gesture. When the device determines that the touch events correspond to a scaling gesture, the device may apply a smoothing filter to data corresponding to the touch event. The smoothing filter may be a Kalman based filter. The device may perform a scaling operation using the filtered data. When the device determines that the touch events do not correspond to a scaling gesture, to reduce latency, the smoothing filter may not be applied.

### TECHNICAL FIELD

This disclosure relates to systems and methods for processing user inputs and more particularly to processing user touch gestures.

### BACKGROUND

Devices including laptop or desktop computers, tablet computers, televisions, computer monitors, digital media players, digital cameras, video gaming devices, smart phones, and cellular telephones may include touchscreen displays. A touchscreen display may include a transparent touch-sensitive surface overlaid on a display. The touch-sensitive surface may include one or more sensors that generate signals corresponding to a user touch event. A user may perform various operations, for example, inputting text, selecting icons, inputting commands, browsing multimedia content, browsing the internet, and performing zoom and pan operations, by activating the touch-sensitive surface in a particular manner.

Signals corresponding to a user touch event may include noise. When noise is present in a signal corresponding to a user touch event it may be difficult for a device to interpret a user operation. Current techniques for reducing noise present in a signal corresponding to a user touch event may be detrimental to the user's experience.

### SUMMARY

In general, this disclosure describes techniques for processing user touch gestures. In particular, this disclosure describes techniques for selectively applying filters to user touch inputs based on a detected gesture. In some examples, the techniques may be implemented in a mobile device with an integrated touchscreen display, such as, for example, a smart phone.

According to one example of the disclosure, a method for selectively filtering touch input comprises receiving a plurality of touch events, determining whether the plurality of touch events correspond to a scaling gesture, upon determining that the plurality of touch events correspond to a scaling gesture, applying a smoothing filter to data corresponding to the plurality of touch events, and performing a scaling operation using the filtered data.

According to another example of the disclosure an apparatus for selectively filtering touch input comprises means for receiving a plurality of touch events means for determining whether the plurality of touch events correspond to a scaling gesture, means for upon determining that the plurality of touch events correspond to a scaling gesture, applying a smoothing filter to data corresponding to the plurality of touch events, and means for performing a scaling operation using the filtered data.

According to another example of the disclosure a non-transitory computer-readable storage medium has instructions stored thereon that upon execution cause one or more processors of a device to receive a plurality of touch events, determine whether the plurality of touch events correspond to a scaling gesture, upon determining that the plurality of touch events correspond to a scaling gesture, applying a smoothing filter to data corresponding to the plurality of touch event, and perform a scaling operation using the filtered data.

According to another example of the disclosure a device for selectively filtering touch input, comprises a touch screen configured to receive user touch input, and one or more processors configured to receive a plurality of touch events, determine whether the plurality of touch events correspond to a scaling gesture, and upon determining that the plurality of touch events correspond to a scaling gesture, apply a smoothing filter to data corresponding to the touch events, and perform a scaling operation using the filtered data.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example of a computing device that may implement one or more techniques of this disclosure.

FIG. 2 is a block diagram illustrating a detailed view of an example computing device that may implement one or more techniques of this disclosure.

FIG. 3 is a conceptual diagram illustrating an example of a touch gesture in accordance with one or more techniques of this disclosure.

FIG. 4A is a conceptual diagram illustrating example data associated with a user touch gesture in accordance with one or more techniques of this disclosure.

FIG. 4B is a conceptual diagram illustrating example data associated with a user touch gesture in accordance with one or more techniques of this disclosure.

FIG. 5 is a flowchart illustrating an example method for processing user touch input according to the techniques of this disclosure.

### DETAILED DESCRIPTION

A touchscreen may include sensors that measure a change in an electromagnetic parameter based on a user touch input. For example, when a user touches a touch-sensitive surface of a capacitive touchscreen, the user's touch causes a change in a local electrostatic field. The change in the local electrostatic field can be measured as a change in capacitance. Because ambient conditions may also cause a change in electromagnetic parameters, a large amount of noise may be present in typical touchscreen sensor measurements. Changes in touchscreen sensor measurements caused by user activity (e.g., pressing down, lifting up, and sliding) may be referred to as touch events. A plurality of touch events may be combined to form a gesture. Examples of gestures include a double tap gesture, a single-finger panning gesture, and a pinch-zooming gesture.

Noise introduced in a touchscreen measurement can cause user touch events to be less precise which may make it more difficult for a device to identify a gesture including multiple user touch events and further cause an application's response to a gesture to appear jittery. To reduce the amount of noise included in touch events and thus, reaching applications reacting to a user's touch gestures, system level filtering may be implemented in either hardware or software. Although filtering may reduce noise, strong filtering may increase touch latency and in the case of some filters may also cause a touch response to overshoot. For some gestures, such as, for example, pinch-zooming gestures, the effects of jitter and overshoot may be magnified. For other gestures, such as, for example, a single-finger panning gestures the effects of jitter and overshoot may be less severe, but latency caused by filtering may be noticeable to a user. For example, pinch-zooming gestures may scale the content on a screen fractionally and a one-pixel change of a touch point measurement can cause content to move several pixels at the edges of the screen. However, a one-pixel change of a touch point measurement included in a single finger panning gesture may not cause nearly as noticeable an effect. This disclosure describes techniques for selectively applying filters to user touch inputs based on a detected gesture. The techniques described herein may be used to reduce the effects of noise present in touch screen measurements while reducing the effects of overshoot and latency caused by filtering.

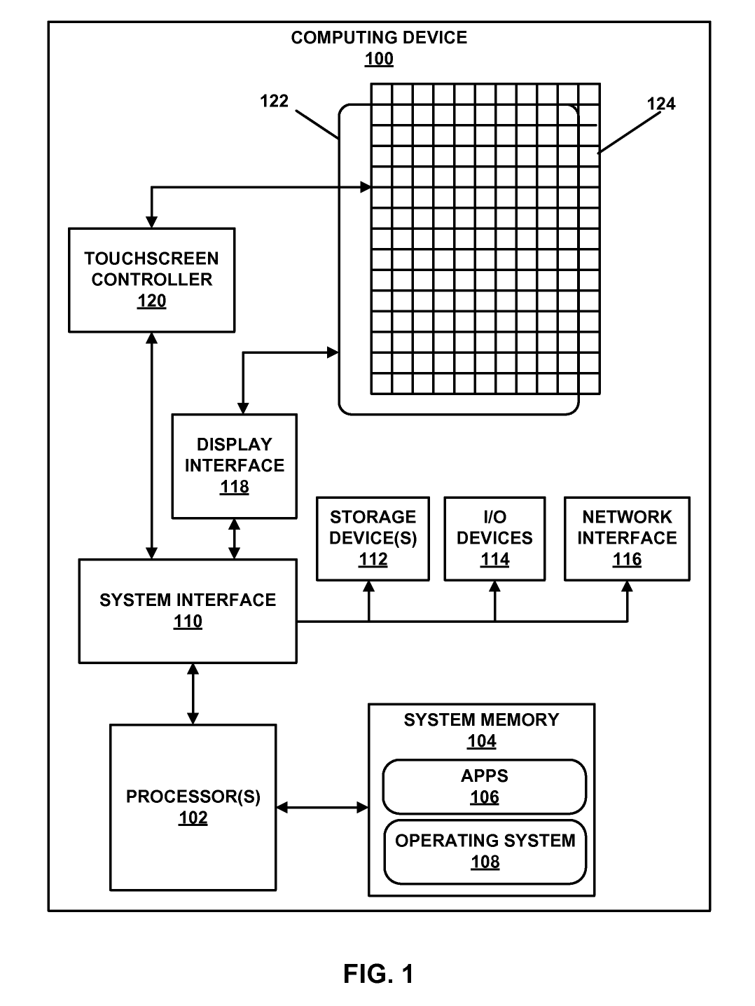

FIG. 1 is a block diagram illustrating an example of a computing device that may implement one or more techniques of this disclosure. Computing device 100 is an example of a computing device that may be configured to receive user input and execute one or more applications. Computing device 100 may include or be part of any device configured to receive user input and execute one or more applications. For example, computing device 100 may include devices, such as, for example, desktop or laptop computers, mobile devices, smartphones, cellular telephones, personal data assistants (PDA), tablet devices, set top boxes, and personal gaming devices. Computing device 100 may be equipped for wired and/or wireless communications. In one example, computing device 100 may be configured to receive and process user touch inputs.

Computing device 100 includes processor(s) 102, system memory 104, system interface 110, storage device(s) 112, I/O device(s) 114, network interface 116, display interface 118, touchscreen controller 120, display 122, and touch-sensitive surface 124. As illustrated in FIG. 1, system memory 104 includes applications 106 and operating system 108. It should be noted that although example computing device 100 is illustrated as having distinct functional blocks, such an illustration is for descriptive purposes and does not limit computing device 100 to a particular hardware architecture. Functions of computing device 100 may be realized using any combination of hardware, firmware and/or software implementations.

Processor(s) 102 may be configured to implement functionality and/or process instructions for execution in computing device 100. Processor(s) 102 may be capable of retrieving and processing instructions, code, and/or data structures for implementing one or more of the techniques described herein. Instructions may be stored on a computer readable medium, such as memory 104 or storage devices 112. Processor(s) 102 may include digital signal processors (DSPs), general purpose microprocessors, application specific integrated circuits (ASICs), field programmable logic arrays (FPGAs), or other equivalent integrated or discrete logic circuitry. Processors (s) 102 may include multi-core central processing units. Processor(s) 102 may include dedicated graphic processing units for graphics processing.

System memory 104 may be configured to store information that may be used by computing device 100 during operation. System memory 104 may be used to store program instructions for execution by processor(s) 102 and may be used by software or applications running on computing device 100 to temporarily store information during program execution. For example, system memory 104 may store instructions associated with applications 106 and operating system 108. Applications 106 may include any applications implemented within or executed by computing device 100 and may be implemented or contained within, operable by, executed by, and/or be operatively/communicatively coupled to components of computing device 100. Applications 106 may include instructions that may cause processor(s) 102 of computing device 100 to perform particular functions. Applications 106 may include algorithms which are expressed in computer programming statements, such as, for-loops, while-loops, if-statements, do-loops, etc.

As illustrated in FIG. 1, applications 106 may execute “on top of” operating system 108. That is, operating system 108 may be configured to facilitate the interaction of applications 106 with hardware components of computing device 100, such as, for example, processor(s) 102. Operating system 108 may be an operating system designed to be installed on laptops, desktops, smartphones, tablets, set-top boxes, and/or gaming devices. For example, operating system 108 may be a Windows®, Linux, Mac OS, Android, iOS, Windows Mobile®, or a Windows Phone® operating system. As described in detail below, operating system 108 and applications 106 may be configured to receive and process touch events according to the techniques described herein.

System memory 104 may be described as a non-transitory or tangible computer-readable storage medium. In some examples, system memory 104 may provide temporary memory and/or long-term storage. In some examples, system memory 104 or portions thereof may be described as non-volatile memory and in other examples portions of system memory 104 may be described as volatile memory. Examples of volatile memories include random access memories (RAM), dynamic random access memories (DRAM), and static random access memories (SRAM). Examples of non-volatile memories include magnetic hard discs, optical discs, floppy discs, flash memories, or forms of electrically programmable memories (EPROM) or electrically erasable and programmable (EEPROM) memories.

System interface 110 may be configured to enable communication between components of computing device 100. In one example, system interface 110 comprises structures that enable data to be transferred from one peer device to another peer device or to a storage medium. For example, system interface 110 may include a chipset supporting a bus protocol, such as, for example, Advanced Microcontroller Bus Architecture (AMBA) bus protocols, Peripheral Component Interconnect (PCI) bus protocols, or any other form of structure that may be used to interconnect peer devices.

Storage device(s) 112 represent memory of computing device 100 that may be configured to store relatively larger amounts of information for relatively longer periods of time than system memory 104. Similar to system memory 104, storage device(s) 112 may also include one or more non-transitory or tangible computer-readable storage media. Storage device(s) 112 may be internal or external memory devices and in some examples may include volatile and/or non-volatile storage elements. Examples of memory devices include file servers, an FTP servers, network attached storage (NAS) devices, a local disk drive, or any other type of device or storage medium capable of storing data. Storage medium may include Blu-ray discs, DVDs, CD-ROMs, flash memory, or any other suitable digital storage media. When the techniques described herein are implemented partially in software, a device may store instructions for the software in a suitable, non-transitory computer-readable medium and execute the instructions in hardware using one or more processors.

Network interface 116 may be configured to enable computing device 100 to communicate with external computing devices via one or more networks. Network interface 116 may include network interface card, such as an Ethernet card, an optical transceiver, a radio frequency transceiver, or any other type of device that can send and receive information. Network interface 116 may be configured to operate according to one or more of the communication protocols associated with a packet-based network, such as a local area network, a wide-area network, or a global network such as the Internet. Examples of communication protocols include Global System Mobile Communications (GSM) standards, code division multiple access (CDMA) standards, 3rd Generation Partnership Project (3GPP) standards, Internet Protocol (IP) standards, Wireless Application Protocol (WAP) standards, and/or IEEE standards, such as, one or more of the 802.11 standards, as well as various combinations thereof.

I/O device(s) 114 may be configured to receive input and provide output during operation of computing device 100. Input may be generated from an input device, such as, for example, touch-sensitive screen, track pad, track point, mouse, a keyboard, a microphone, video camera, or any other type of device configured to receive input. Output may be provided to output devices, such as, for example speakers or a display device. In some examples, I/O device(s) 114 may be external to computing device 100 and may be operatively coupled to computing device 100 using a standardized communication protocol, such as for example, Universal Serial Bus protocol (USB), High-Definition Multimedia Interface (HDMI), Digital Visual Interface (DVI), DisplayPort, and Video Graphic Array (VGA). In some examples, I/O device(s) 114 may include an external touchscreen display device. In should be noted that although the techniques described herein are described with respect to an integrated touchscreen display, the techniques described herein are equally applicable to external touchscreen display devices (e.g., touchscreen remote controllers).

As described above, computing device 100 may be configured to receive and process user touch inputs. As illustrated in FIG. 1, computing device 100 includes display 122 and touch-sensitive surface 124. Display 122 and touch-sensitive surface 124 may jointly be referred to as a touchscreen display. Display 122 may be configured to provide visual output generated during the operation of computing device 100. Visual output may include graphical user interfaces (GUI), such as, for example, a virtual keyboard. Display 122 may include a cathode ray tube (CRT) monitor, a liquid crystal display (LCD), or any other type of device that can provide output. In some examples, display 122 may be an integrated display. In the example where computing device 100 is a mobile device, display 122 may include an integrated organic light emitting diode (OLED) display. As illustrated in FIG. 1, display 122 is operably coupled to display interface 118. Display 122 may be configured to provide visual output based on data received from display interface 118.

Touch-sensitive surface 124 may be configured to receive a user touch event. Touch-sensitive surface 124 may be transparent and may include multiple layers of thin films. Touch-sensitive surface 124 may be configured to generate a change in an electromagnetic property based on a user touch input. Touch-sensitive surface 124 may include resistive touch sensors, capacitive touch sensors, and/or any other type of touch sensors. Touch-sensitive surface 124 may be configured to receive user input using a stylus, through direct contact with a user's skin, and/or through indirect contact with a user's skin (e.g., through a glove). Touch-sensitive surface 124 may provide measurements corresponding to the pressure, location (e.g., X and Y coordinates), and area of a touch event. Touch-sensitive surface 124 may be configured as a multi-touch touch surface. That is, touch-sensitive surface 124 may be configured to receive multiple user inputs occurring simultaneously at different locations.

Touchscreen controller 122 may be configured to receive an analog sensor measurement and provide information associated with measurements to other components of computing device 100. It should be noted that information associated with touch-sensitive surface 124 measurements may be output by touchscreen controller 122 in several forms. In one example, touchscreen controller 122 may process analog measurement data and output touch events in a format defined according to operating system 108. For example, touchscreen controller 122 may be configured to convert analog measurement data into digital data for use by operating system 108. The techniques described herein may be applicable to any type of touch controller.

As described above, a plurality of touch events may be combined to form a gesture. Examples of gestures include a tap gesture, a double tap gesture, a single-finger panning gesture, a flick gesture, a scroll gesture, and a pinch-zooming gesture. Each on these gestures may include multiple versions thereof. Version 4.3 of the Android operating system, the public interface documentation which is available at http://developer.android.com/reference/packages.html as of Sep. 10, 2013 and is incorporated by reference, defines a gesture as hand-drawn shape on a touchscreen. Android 4.3 interprets gestures from one or more received motion event objects defined by the MotionEvent class. Android 4.3 defines the following simple gestures: single-tap, double-tap, fling, long press, and scroll. Further, Android 4.3 defines the more complex gestures such as scale and drag gestures. The complexity of a gesture may be based on the number of simultaneous touch points are needed to complete the gesture or in the case of Android, the number of motion events required to complete a gesture. For example, a tap gesture may only require that a user touch a point on the touch screen using a single finger, whereas a scaling gesture may require multiple simultaneous touch points. Thus, in one example, simple gestures may correspond to single touch point gestures and complex gestures may correspond to multi-touch gestures. It should be noted that although examples are described with respect to an Android operating system, the examples described herein are generally applicable to other operation systems. For example, the techniques herein may be applied to rotation gestures defined and supported by applications.

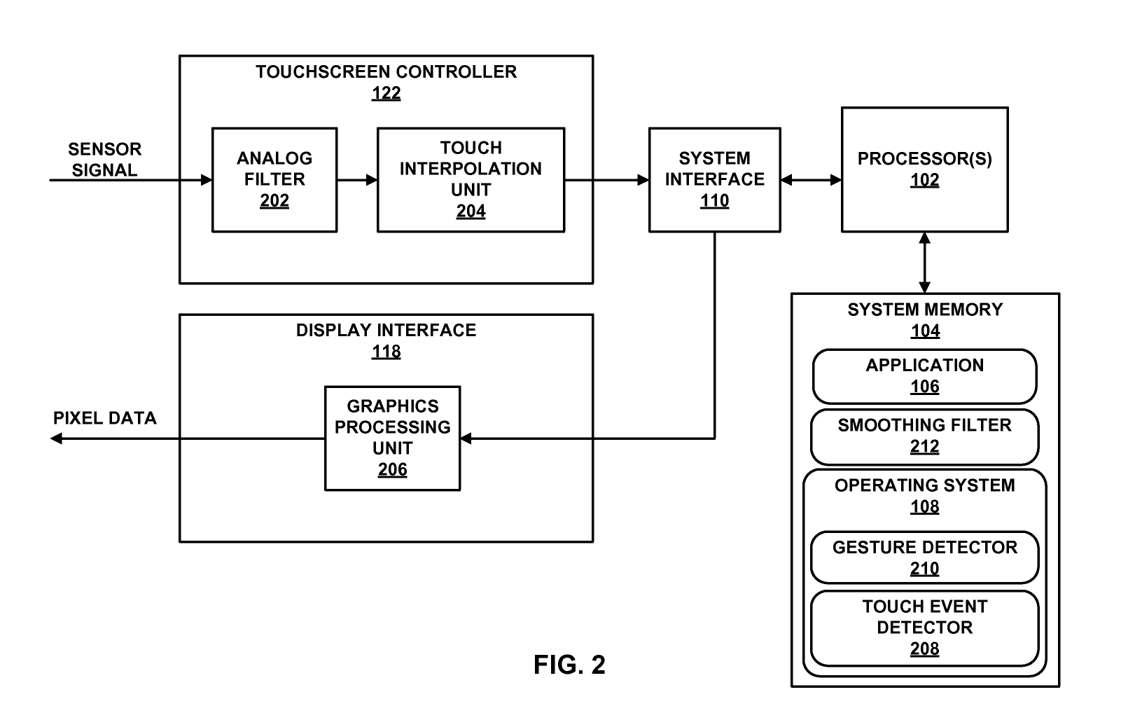

FIG. 2 is a block diagram illustrating a detailed view of example computing device 100. In the example illustrated in FIG. 2, touchscreen controller 122 includes analog filter 202 and touch interpolation unit 204. As further illustrated in FIG. 2, display interface 118 includes graphics processing unit 206 and operating system 108 includes touch event detector 208 and gesture detector 210. Further, system memory 104 includes smoothing filter 212. It should be noted that functions described with respect to FIG. 2 may be realized using any combination of hardware, firmware and/or software implementations. As described above, touchscreen controller 122 may be configured to receive analog signals corresponding to a sensor measurement and ambient conditions may cause a significant amount of noise to be present in a sensor measurement. Analog filter 202 may be configured to filter an analog signal corresponding to a sensor measurement. For example, analog filter 202 may be a low-pass filter, a band-pass filter, or a high-pass filter configured to filter a particular type of ambient noise. For example, in the example where computing device 100 is a smart phone, analog filter 202 may be configured to filter a known noise characteristic associated with an integrated display of the computing device 100. It should be noted that, in some examples, analog filter 202 may be applied indiscriminately to all signals corresponding to touch sensor measurements. In other examples, analog filter 202 may be selectively applied.

As illustrated in FIG. 2, the output of analog filter 202 is received by touch interpolation unit 204. Touch interpolation unit 204 is configured to output touch information corresponding to sensor measurements. For example, interpolation unit 204 may be configured to process analog measurement data and output data in a format that may be used by operating system 108 to record a touch event. In the example where operating system 108 is an Android operating system, touch interpolation unit 204 may be configured to output data that may be used by operating system 108 to define a motion event object, where a motion event object includes an action code, a set of axis values that include X and Y coordinates of the touch, and information about the pressure, size and orientation of the contact area.

Touch event detector 208 may be configured to receive data from touch interpolation unit 204 and generate a touch event as defined according to a particular operating system. In one example, touch event detector 208 may be configured to generate motion events according to MotionEvent class defined by Android 4.3. As described above, a plurality of touch events may be combined to form a gesture. Gesture detector 210 may be configured to receive a plurality of touch events and/or motion events and detect a defined gesture. In one example, application 106 may receive a touch event from touch event detector 208 and send the touch event to gesture detector 210. Application 106 may then receive calls in return from gesture detector, e.g., a Boolean value indicating that a particular gesture was detected and information associated with the gesture.

Application 106 may provide information to graphics processing unit 206 and graphics processing unit 206 may update pixel data such that the displayed image is updated. For example, if a user presses a button displayed as part of a GUI, application 106 may provide information to graphic processing unit 206 to update the GUI is accordance with the user input. Further, application 106 may provide information to graphics processing unit 206 to modify the size of an image appearing on display 122. For example, application 106 may be configured to zoom-in or zoom-out as a user performs pinch-to-zoom operations. Graphics processing unit 206 may operate according to a graphics pipeline process (e.g., input assembler, vertex shader, geometry shader, rasterizer, pixel shader, and output merger). Graphics processing unit 206 may be configured to operate according to OpenGL (Open Graphics Library, managed by the Khronos Group) and/or Direct3D (managed by Microsoft, Inc.), both of which are incorporated by reference herein in their entirety, or another defined graphics application programming interface (API).

As described above, Android 4.3 defines a scale gesture. Android 4.3 includes the ScaleGestureDetector class. It should be noted that the ScaleGestureDetector class has been a part of Android since Android 2.2 Froyo (API level 8), which was published in May 2010. In one example, gesture detector 210 may include the ScaleGestureDetector class defined according to Android. The ScaleGestureDetector class may be used by an application to perform a pinch-to-zoom operation. The ScaleGestureDetector includes the following methods:
getCurrentSpan( ): Return the average distance between each of the pointers forming the gesture in progress through the focal point.
   Returns Distance between pointers in pixels.
getCurrentSpanX( ): Return the average X distance between each of the pointers forming the gesture in progress through the focal point.
   Returns Distance between pointers in pixels.
getCurrentSpanY( ): Return the average Y distance between each of the pointers forming the gesture in progress through the focal point.
   Returns Distance between pointers in pixels.
getEventTime( ): Return the event time of the current event being processed.
   Returns Current event time in milliseconds.
getFocusX( ): Get the X coordinate of the current gesture's focal point. If a gesture is in progress, the focal point is between each of the pointers forming the gesture. If is InProgress( ) would return false, the result of this function is undefined.
   Returns X coordinate of the focal point in pixels.
getFocusY( ): Get the Y coordinate of the current gesture's focal point. If a gesture is in progress, the focal point is between each of the pointers forming the gesture. If is InProgress( ) would return false, the result of this function is undefined.
   Returns Y coordinate of the focal point in pixels.
getPreviouSpan( ): Return the previous average distance between each of the pointers forming the gesture in progress through the focal point.
   Returns Previous distance between pointers in pixels.
getPreviouSpanX( ): Return the previous average X distance between each of the pointers forming the gesture in progress through the focal point.
   Returns Previous distance between pointers in pixels.
getPreviouSpanY( ): Return the previous average Y distance between each of the pointers forming the gesture in progress through the focal point.
   Returns Previous distance between pointers in pixels.
getScaleFactor( ): Return the scaling factor from the previous scale event to the current event. This value is defined as (getCurrentSpan( )/getPreviousSpan( )).
   Returns The current scaling factor.
getTimeDelta( ): Return the time difference in milliseconds between the previous accepted scaling event and the current scaling event.
   Returns Time difference since the last scaling event in milliseconds.
isInProgress( ): Returns true if a scale gesture is in progress.
onTouchEvent (MotionEvent event): Accepts MotionEvents and dispatches events to a ScaleGestureDetector.OnScaleGestureListener when appropriate. Applications should pass a complete and consistent event stream to this method. A complete and consistent event stream involves all MotionEvents from the initial ACTION_DOWN to the final ACTION_UP or ACTION_CANCEL.
Parameters event The event to process
Returns true if the event was processed and the detector wants to receive the rest of the MotionEvents in this event stream.

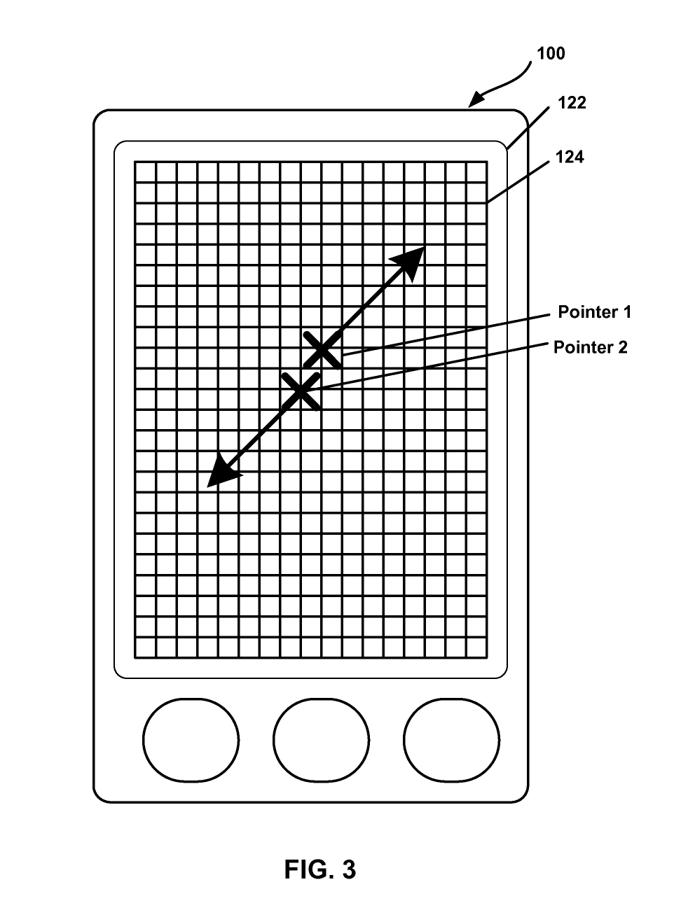

FIG. 3 is a conceptual diagram illustrating an example of a touch gesture in accordance with one or more techniques of this disclosure. FIG. 3 is a conceptual diagram illustrating an example of a pinch-to-zoom gesture. The X's illustrated in FIG. 3 identify two user touch points occurring nearly simultaneously (e.g., thumb and index finger contacting a touchscreen) and the arrows represent the path of the user's fingers along the screen 124. The X's may be referred to as pointers. An application, such as application 106 may receive a touch event from touch event detector 208 and send the touch event on to the gesture detector 210, which may include ScaleGestureDetector. Application 106 may then receive calls in return from the ScaleGestureDetector when a scaling gesture is in progress, and can query the ScaleGestureDetector for how much the scale has changed and the focal point of the scale gesture. Application 106 may then provide information to graphics processing unit 206 so a scaled (i.e., zoomed-in) image appears on display 122.

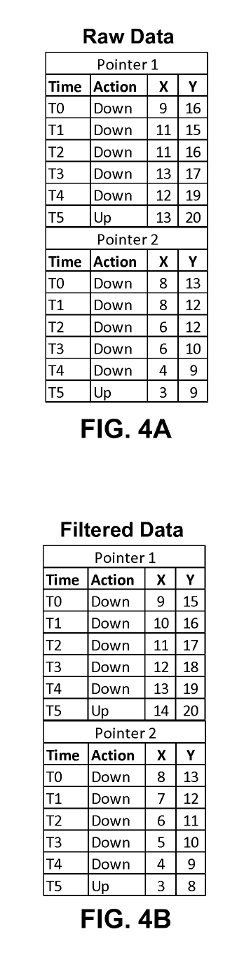

As described above, touch sensor measurements may include noise which may cause touch inputs to be less precise. For example, noise may cause the path of a user's finger to appear non-linear. FIG. 4A is a conceptual diagram illustrating example data associated with a user touch gesture in accordance with one or more techniques of this disclosure. FIG. 4A is a simplified illustrative version of data that may correspond to the gesture illustrated in FIG. 3. FIG. 4A is simplified in that the actual amount data included for the gesture illustrated in FIG. 3 may be much greater and more precise. As illustrated in FIG. 4A, the X and Y coordinates associated with a pointer do not follow a linear path.

As described above, filtering techniques may be used to reduce noise. Referring again to FIG. 2, smoothing filter 212 is an example of a filter that may be used to reduce noise. In the example illustrated in FIG. 2 smoothing filter 212 is illustrated as software. It should be noted that smoothing filter 212 may be realized using any combination of hardware, firmware and/or software implementations. In one example, smoothing filter 212 may be configured to implement Kalman filtering techniques. Kalman filtering techniques use predictive models of how a signal is expected to behave and combines a result from a predictive model with a measurement to get the filtered value. Chih-Chang Lai; Ching-Chih Tsai, “Neural calibration and Kalman filter position estimation for touch panels,” Control Applications, 2004. Proceedings of the 2004 IEEE International Conference on, vol. 2, no., pp. 1491, 1496, 2-4 Sep. 2004, which is incorporated by reference in its entirety, describes a Kalman filter method for estimating the positions of fast-moving touch points in touch panels. In one example, smoothing filter 212 may be configured to implement Kalman filtering techniques described in Lai.

In another example, smoothing filter 212 may be configured to do a prediction by performing extrapolation based on weighted average change over the last few measurements. For example, smoothing filter 212 may operate according to the following equations:

predictionₙ=result₍ₙ₋₁₎+delta₍ₙ₋₁₎ (1)

Pₙ=P₍ₙ₋₁₎*(1−k₍ₙ₋₁₎)+0.1 (2)

deltaₙ=(measurementₙ−measurement₍ₙ₋₁₎+delta₍ₙ₋₁₎*5)/6 (3)

kₙ=Pₙ/(Pₙ+5/(deltaₙ*c+1)) (4)

resultₙ=predictionₙ+kₙ*(measurementₙ−predictionₙ) (5)

where c is a resolution-dependent constant to adjust for overshooting, and measurementₙ is a measurement calculated from touch-sensitive surface 124 at regular time intervals. This measurement can be the x or y distance calculated from the touch point positions supplied by the touch-sensitive surface 124, or the x or y position of the focus point calculated from the touch point positions supplied by the touch-sensitive surface 124. At the start of filtering, result₀ and measurement₀ get initialized to the initial measurement, P₀ may be initialized to 0.7, and delta₀ may be initialized to 0.

FIG. 4B is a conceptual diagram illustrating example data associated with a user touch gesture in accordance with one or more techniques of this disclosure. FIG. 4B is an example of the data illustrated in FIG. 4A after smoother filter 212 has been applied. The example data illustrated in FIG. 4B provides more of a linear path for pointer 1 and pointer 2 than compared to the data illustrated in FIG. 4A. As noted above with respect to FIG. 4A, the actual amount data included for the gesture illustrated in FIG. 3 may be much greater and more precise. Thus, FIGS. 4A and 4B illustrate how a smoothing filter, such as for example, smoothing filter 212 may be used to process raw data for use by an application.

As described above, jitter issues caused by noise are magnified in the case of scaling gestures. However, applying filters to decrease the amount of the jitter in scaling gestures may increase the amount of latency for other gestures, such as single-touch gestures. Thus, computing device 100 may be configured such that smoothing filter 212 includes a separate filtering stage that specifically targets only scaling gestures. For example, one type of Kalman filter, such as, for example, a Kalman filter based on the equations described above, may be used for scaling gestures and a Kalman filter with a less complex predictive model or no Kalman filter may be applied to other gestures, such as, for example, single-tap, double-tap, fling, long press, and scroll gestures. Using separate filtering stages may ensure that the latency of gestures other than scaling gestures is not unnecessarily increased due to by the filtering used for scaling gestures, and the filtering stage could ideally also take into account the characteristics of the touch screen when there are multiple active touch points. It should be noted that multiple separate filtering stages may be used. That is, any and all combinations of filtering stages may be used for a number of possible gestures. For example, a rotation gesture may use a first filtering stage, scaling gesture may use a second filtering stage, and all other gestures may use a third filtering stage.

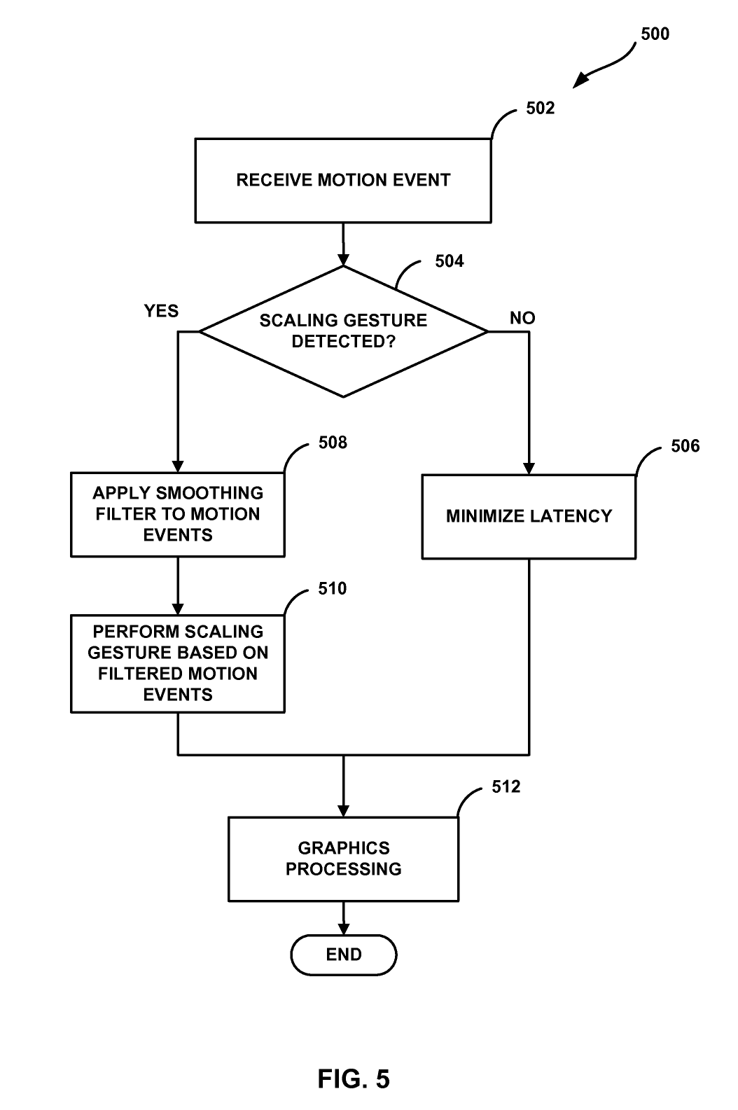

FIG. 5 is a flowchart illustrating an example method for processing user touch input according to the techniques of this disclosure. Although method 500 is described with respect to application 106, touch event detector 208, gesture detector 210, and smoothing filter 212, method 500 may be performed by any combination of components of computing device 100. Gesture detector 210 receives a motion event (502). A motion event may be received from application 106 and/or touch event detector 208. A motion event may be defined according to the MotionEvent class of the Android operating system. Gesture detector 210 determines whether the plurality of touch events corresponds to a scaling gesture (504). In one example, a scaling gesture may be defined according to the ScaleGestureDetector defined according to an Android operating system as described above. In one example, gesture detector may return a value of true for isInProgress( ) if a scaling gesture is detected. As illustrated in FIG. 5, in the case where a scaling gesture is not detected, for example, motion events correspond to another type of gesture, latency may be minimized (506). As described above, latency may be minimized by not applying a filter or a applying a less complex filter. Thus, a filter associated with a scaling gesture may not be applied to other gestures. For example, is a gesture is any one of or all of tap, fling, long press, or scroll, a Kalman filter associated with a scaling gesture may not be applied.

As further illustrated in FIG. 5, in the case where a scaling gesture is detected, for example, a smoothing filter may be applied (508). Smoothing filter may be smoothing filter 212 described above, such as, for example, a Kalman filter. After a smoothing filter has been applied, gesture detector 210 may perform an operation associated with a scaling gesture based on the filtered data (510). For example, gesture detector 210 may perform a getScaleFactor( ) method using the filtered data and provide the scale factor to application 106. Application 106 and graphics processing unit 206 may perform graphics processing based on the scale factor (512). For example, application 106 and graphics processing unit 206 modify the size of an image appearing on the touch screen based on the scaling factor, e.g., zoom-in or zoom-out based on the rate at which a user performs a pinch-to-zoom operation.

In this manner, computing device 100 represents an example of a computing device configured to receive a plurality of touch events, determine whether the plurality of touch events correspond to a scaling gesture, upon determining that the plurality of touch events correspond to a scaling gesture, apply a smoothing filter to data corresponding to the plurality of touch events, and perform a scaling operation using the filtered data. It should be noted that the techniques described with respect in method 500 may be superior to a simpler approach of filtering each touch point's position separately, regardless of gesture type. That is, filtering each touch point's position regardless of gesture type may either add unnecessarily large latency to simple gestures, such as single-finger panning gestures, or may be insufficient for smoothing out more complex gestures such as pinch-zooming gestures.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for selectively filtering touch input, the method comprising:
receiving a plurality of touch events;
determining whether the plurality of touch events correspond to a scaling gesture;
upon determining that the plurality of touch events correspond to a scaling gesture, applying a smoothing filter to data corresponding to the plurality of touch events; and
performing a scaling operation using the filtered data.

2. The method of claim 1, wherein receiving a plurality of touch events includes generating a motion event defined according to an Android operating system.

3. The method of claim 1, wherein applying a smoothing filter to data corresponding to the plurality of touch event includes applying a Kalman filter.

4. The method of claim 1, wherein applying a smoothing filter to data corresponding to the plurality of touch event includes applying a filter based on the following equation:
resultₙ=predictionₙ+kₙ*(measurementₙ−predictionₙ);
where kₙ and predictionₙ are based on measurement₍ₙ₋₁₎, and wherein n and n−1 correspond to regular time intervals.

5. The method of claim 1, wherein performing a scaling operation using the filtered data includes providing a scale factor to an application.

6. The method of claim 1, further comprising upon determining that the plurality of touch events corresponds to one of a tap, fling, long press, or scroll, not applying the smoothing filter.

7. A non-transitory computer-readable storage medium having instructions stored thereon that upon execution cause one or more processors of a device to:
receive a plurality of touch events;
determine whether the plurality of touch events correspond to a scaling gesture;
upon determining that the plurality of touch events correspond to a scaling gesture, apply a smoothing filter to data corresponding to the plurality of touch events; and
perform a scaling operation using the filtered data.

8. The non-transitory computer-readable storage medium of claim 7, wherein receiving a plurality of touch events includes generating a motion event defined according to an Android operating system.

9. The non-transitory computer-readable storage medium of claim 7, wherein applying a smoothing filter to data corresponding to the plurality of touch event includes applying a Kalman filter.

10. The non-transitory computer-readable storage medium of claim 7, wherein applying a smoothing filter to data corresponding to the plurality of touch event includes applying a filter based on the following equation:
resultₙ=predictionₙ+kₙ*(measurementₙ−predictionₙ);
where kₙ and predictionₙ are based on measurement₍ₙ₋₁₎, and wherein n and n−1 correspond to regular time intervals.

11. The non-transitory computer-readable storage medium of claim 7, wherein performing a scaling operation using the filtered data includes providing a scale factor to an application.

12. The non-transitory computer-readable storage medium of claim 7, further comprising instructions that upon execution cause one or more processors of a device to upon determining that the plurality of touch events corresponds to one of a tap, fling, long press, or scroll, not applying the smoothing filter.

13. A device for selectively filtering touch input, the device comprising:
a touch screen configured to receive user touch input; and
one or more processors configured to:
receive a plurality of touch events;
determine whether the plurality of touch events correspond to a scaling gesture;
upon determining that the plurality of touch events correspond to a scaling gesture, apply a smoothing filter to data corresponding to the plurality of touch events; and
perform a scaling operation using the filtered data.

14. The device of claim 13, wherein receiving a touch event includes generating a motion event defined according to an Android operating system.

15. The device of claim 13, wherein applying a smoothing filter to data corresponding to the plurality of touch event includes applying a Kalman filter.

16. The device of claim 13, wherein applying a smoothing filter to data corresponding to the plurality of touch event includes applying a filter based on the following equation:
resultₙ=predictionₙ+kₙ*(measurementₙ−predictionₙ);
where kₙ and predictionₙ are based on measurement₍ₙ₋₁₎, and wherein n and n−1 correspond to regular time intervals.

17. The device of claim 13, wherein performing a scaling operation using the filtered data includes providing a scale factor to an application.

18. The device of claim 13, further comprising upon determining that the plurality of touch events corresponds to one of a tap, fling, long press, or scroll, not applying the smoothing filter.

19. The device of claim 17, wherein performing a scaling operation using the filtered data further includes modifying the size of an image appearing on the touch screen based on the scaling factor.

20. The device of claim 13, wherein the device is a mobile phone.
